(19) United States
(12) Patent Application Publication
(10) Pub. No.: US 2002/0077248 A1
(43) Pub. Date: Jun. 20, 2002

(54) Ceramic carrier and ceramic catalyst body

(76) Inventors: Tomohiko Nakanishi, Nishio-shi (JP); Kazuhiko Koike, Nishio-shi (JP); Masakazu Tanaka, Okazaki-city (JP); Tosiharu Kondo, Toyoake-city (JP); Takashi Kondo, Kariya-city (JP); Tomomi Hase, Kariya-city (JP); Jun Hasegawa, Hekinan-city (JP)

Correspondence Address: LAW OFFICE OF DAVID G POSZ, 2000 L STREET, N.W., SUITE 200, WASHINGTON, DC, 20036, US

(21) Appl. No.: 09/961,203

(22) Filed: Sep. 24, 2001

(30) Foreign Application Priority Data
Sep. 29, 2000 (JP) 2000-297944
Jul. 30, 2001 (JP) 2001-229018

(51) Int. Cl. B01J 23/58

(52) U.S. Cl. 502/302; 502/439; 502/527.14; 502/328; 502/330

(57) ABSTRACT

The present invention provides a ceramic carrier and a ceramic catalyst which have NOx absorbent capacity, low heat capacity, low pressure loss and high practical value.

According to the present invention, defects are formed by substituting a part of the constituent elements of cordierite with elements which have NOx absorbent capacity, thereby to form a multitude of pores that are capable of directly supporting a catalyst component on the ceramic surface and a ceramic carrier having NOx absorbent capacity is obtained. Since it is not necessary to form a γ-alumina coating layer, a NOx storage-reduction catalyst having small heat capacity and low pressure loss can be obtained.

### BACKGROUND OF THE INVENTION

1. Field of the Invention

The present invention relates to a ceramic carrier used as a carrier for supporting a catalyst component in a catalyst for purifying exhaust gas from an automobile engine or the like, and to a ceramic catalyst body.

2. Description of the Related Art

There are increasing demands in recent years to reduce the CO₂ emission from automobiles through improvement in mileage and cleaning the exhaust gas, for protection of the global environment. Accordingly, measures such as lean burn operation of the engine and the use of an NOx storage-reduction catalyst are increasingly employed. The NOx storage-reduction catalyst having a constitution such as, for example, a cordierite honeycomb structure having high heat resistance is used as a carrier a surface of which is coated with a material that has large specific surface area such as γ-alumina, with a noble metal catalyst such as Pt or Rh and an assisting catalyst which adsorbs NOx being supported thereon. The assisting catalyst constituted from an alkali metal or an alkali earth metal adsorbs NOx molecules which are released in a lean atmosphere, and releases the NOx in a rich atmosphere to be reduced by the noble metal catalyst. Thus, NOx can be detoxified.

The NOx storage-reduction catalyst of the prior art is coated with a material of large specific surface area, because the cordierite honeycomb structure of the prior art does not have a specific surface area large enough to carry the required amount of catalyst component. However, when the surfaces of the carrier cell walls of the honeycomb structure are coated with a material of large specific surface area, the heat capacity of the carrier increases due to the increase in mass, which is undesirable in view of early activation of the catalyst. The coating method also has a problem in that the decrease in the opening area of the cell of the honeycomb structure leads to an increase in the pressure loss.

The inventors of the present application previously proposed a ceramic carrier which can support a required amount of catalyst component without forming a coating layer so as to increase the specific surface area of the carrier (Japanese Patent Application No. 2000-104994).

### SUMMARY OF THE INVENTION

An object of the present invention is to provide a ceramic carrier and a ceramic catalyst body which have NOx absorbent capacity, low heat capacity, low pressure loss and high practical value, by applying the ceramic carrier described above to the NOx storage-reduction catalyst.

According to a first aspect of the invention, the ceramic carrier comprises a substrate ceramic and a multitude of pores or element capable of supporting a catalyst component directly on the surface of the substrate ceramic, which contains metal elements having NOx absorbent capacity. By forming the multitude of microscopic pores on the surface of the ceramic substrate or by providing an element which chemically bonds with the catalyst component, it is possible to support the catalyst component directly without forming a coating layer. Moreover, a high performance ceramic carrier which has catalyst supporting capacity and NOx absorbent capacity is obtained by including a metal element which has NOx absorbent capacity.

According to a second aspect of the invention, the pores which are capable of directly supporting the catalyst component comprise at least one kind selected from among a group consisting of, for example, defects in the ceramic crystal lattice, microscopic cracks in the ceramic surface and missing defects of the element which constitutes the ceramic. Since these defects have extremely small sizes, such as the defects in the ceramic crystal lattice being on the order of several angstroms and the microscopic cracks formed by thermal shock or the like being several nano-meters, pores which can directly support catalyst component can be formed without decreasing the carrier strength.

The element capable of directly supporting the catalyst component is an element which substitutes a part of the elements which constitute the ceramic substrate. By substituting the constituent element with an element which can chemically bond with the catalyst component, for example, the catalyst can be supported directly on the substituting element.

According to a third aspect of the invention, it is possible to form the defects in the crystal lattice which make the pores capable of directly supporting the catalyst component and to render NOx absorbent capacity, by substituting a part of the constituent elements of the substrate ceramic with the metal element which has NOx absorbent capacity.

According to a fourth aspect of the invention, NOx absorbent capacity can be rendered also by supporting the metal element which has the NOx absorbent capacity in the pores that are capable of directly supporting the catalyst component.

According to a fifth aspect of the invention, for example an alkali metal element, alkali earth metal element, rare earth element or transition metal element is preferably used for the metal element which has the NOx absorbent capacity.

According to a sixth aspect of the invention, a ceramic substrate which includes cordierite as a major component is preferably used because of its high thermal shock resistance.

According to a seventh aspect of the invention, the carrier may have a shape of at least one kind of honeycomb, pellet, powder, foam body, fiber or hollow fiber.

According to an eighth aspect of the invention, the pores which can directly support the catalyst component have diameter or width preferably 1000 times the diameter of the catalyst component ion to be supported therein or smaller and the density of pores is 1×10¹¹/L or higher in order to be capable of supporting a catalyst component of a quantity comparable to that of the prior art.

According to a ninth aspect of the invention, the ceramic catalyst comprising the ceramic carrier of claim 1 and a catalyst component supported directly on the surface the ceramic carrier without forming a coating layer. The ceramic catalyst has low heat capacity and low pressure loss and does not have a high coefficient of thermal expansion, since no coating layer is formed thereon.

According to a tenth aspect of the invention, when the catalyst component is supported in the vicinity of the metal element which has the NOx absorbent capacity, NOx can be reduced efficiently, thereby improving the catalyst performance.

According to an eleventh aspect of the invention, for example, a noble metal is preferably used as the catalyst component.

### BRIEF DESCRIPTION OF THE DRAWINGS

FIGS. 1(a) and 1(b) schematically show the constitution of the ceramic catalyst body of the invention, and

FIG. 1(c) schematically shows the constitution of a ceramic catalyst body of the prior art.

FIGS. 2(a) and 2(b) show the constitution provided with means for supplying energy to the ceramic catalyst body of the invention.

FIGS. 3(a) to 3(c) show examples of the shape of the ceramic catalyst body of the invention,

FIG. 3(a) showing a foam body,

FIG. 3(b) showing fibers and

FIG. 3(c) showing hollow fibers.

FIG. 4(a) schematically shows the constitution of the ceramic catalyst body of Examples 1 to 6,

FIG. 4(b) schematically shows the constitution of the ceramic catalyst body of Examples 7 to 10, and

FIG. 4(c) schematically shows the constitution of the ceramic catalyst body of Comparative Example 1.

### DESCRIPTION OF THE PREFERRED EMBODIMENTS

The invention will now be described in detail below. A ceramic carrier of the invention has a multitude of pores or elements, capable of directly supporting the catalyst component, being provided on the surface of a ceramic substrate, and includes metal element which has NOx absorbent capacity. The ceramic carrier of the invention is made preferably in a cordierite honeycomb structure constituted mainly from cordierite having a theoretical composition of 2MgO.2Al₂O₃.5SiO₂. The main component of the ceramic may also be alumina, spinel, aluminum titanate, silicon carbide, mullite or the like, besides cordierite.

The first feature of the invention is that the ceramic carrier has a multitude of pores which are capable of directly supporting the catalyst component and are provided on the surface of the ceramic substrate. The pores comprise at least one kind selected from among a group consisting of defects in the ceramic crystal lattice (oxygen defect or lattice defect), microscopic cracks in the ceramic surface and missing defects of the elements which constitute the ceramic. Thus it is made possible to directly support the catalyst component without forming a coating layer of a material which has a large specific surface area, such as γ-alumina. Since the diameter of the ions of the catalyst component is typically about 0.1 nm, the diameter or width of the pores formed on the cordierite surface is not larger than 1000 times (100 nm) the diameter of the ions of the catalyst component, preferably in a range from 1 to 1000 times (0.1 to 100 nm). Pore depth is preferably a half (0.05 nm) of the diameter of the catalyst ion or larger. In order to support a catalyst component of a quantity comparable to that of the prior art (1.5 g/L) with the pores of the dimensions described above, the density of the pores is 1×10¹¹/L or higher, preferably 1×10¹⁶/L or higher and more preferably 1×10¹⁷/L or higher.

Among the pores formed in the ceramic surface, the defects in the crystal lattice are classified into oxygen defect and lattice defect (metal vacancy and lattice strain). Oxygen defect is caused by the lack of oxygen atoms which constitute the crystal lattice of the ceramic, and allows it to support the catalyst component in the vacancy left by the missing oxygen. Lattice defect is caused by trapping of more oxygen atoms than necessary to form the ceramic crystal lattice, and allows it to support the catalyst component in the pores formed by the strains in the crystal lattice or the metal vacancies.

Oxygen defects may be formed in the crystal lattice as described in Japanese Patent Application No. 2000-104994, in a process after forming and degreasing, by sintering a material for cordierite which includes an Si source, Al source and Mg source while either \mathring{1} decreasing the pressure of the sintering atmosphere or making it a reducing atmosphere; \mathring{2} sintering in a low-oxygen concentration atmosphere using a compound which does not include oxygen for at least a part of the raw material so as create oxygen deficiency in the sintering atmosphere or in the starting material; or \mathring{3} substituting at least one of the constituent elements of the ceramic except for oxygen with an element having a value of valence lower than that of the substituted element. In the case of cordierite, since the constituent elements have positive valence, such as Si (4+), Al (3+) and Mg (2+), substituting these elements with an element of lower value of valence leads to deficiency of positive charge which corresponds to the difference from the substituting element in the value of valence and to the amount of substitution. Thus, O (2−) having negative charge is released so as to maintain the electrical neutrality of the crystal lattice, thereby forming the oxygen deficiency.

Lattice defects can be formed by \mathring{4} substituting a part of the constituent elements of the ceramic except for oxygen with an element which has a value of valence higher than that of the substituted element. When at least part of Si, Al and Mg, which are constituent elements of the cordierite, is substituted with an element having a value of valence higher than that of the substituted element, positive charge which corresponds to the difference from the substituting element in the value of valence and to the amount of substitution becomes redundant, so that a required amount of O (2−) having negative charge is taken in order to maintain the electrical neutrality of the crystal lattice. The oxygen atoms which have been taken into the crystal are an obstacle for the cordierite unit crystal lattice in forming an orderly structure, thus resulting in lattice strain. Alternatively, part of Si, Al and Mg is released to maintain the electrical neutrality of the crystal lattice, thereby forming vacancies. In this case, sintering is carried out in an air atmosphere so as to ensure a sufficient supply of oxygen. Since the sizes of these defects are believed to be on the order of several angstroms or smaller, they are not accounted for in the specific surface area measured by ordinary methods such as the BET method which uses nitrogen molecules.

The number of oxygen defects and lattice defects is related to the amount of oxygen included in the cordierite honeycomb structure, and it is possible to support the required quantity of catalyst component by controlling the amount of oxygen below 47 wt % (oxygen defect) or over 48 wt % (lattice defect). When the amount of oxygen is decreased to below 47 wt % due to the formation of oxygen defects, the number of oxygen atoms included in the cordierite unit crystal lattice becomes less than 17.2, and the lattice constant for the bₒ axis of the cordierite crystal becomes smaller than 16.99. When the amount of oxygen is increased above 48 wt % due to the formation of the lattice defects, the number of oxygen atoms included in the cordierite unit crystal lattice becomes larger than 17.6, and the lattice constant for the bₒ axis of the cordierite crystal becomes larger or smaller than 16.99.

Among the pores which can support the catalyst, microscopic cracks in the ceramic surface are formed in multitude at least in one of amorphous phase and crystal phase by applying thermal shock or shock waves to the cordierite honeycomb structure. The cracks are required to be small, about 100 nm or less, preferably 10 nm or smaller in width, in order to ensure the mechanical strength of the honeycomb structure.

Thermal shock can be applied by quenching a cordierite honeycomb structure which has been heated. The timing of applying the thermal shock may be after the cordierite crystal phase or amorphous phase has been formed in the cordierite honeycomb structure. Thermal shock may be applied either by forming, degreasing and sintering a material for cordierite which includes an Si source, an Al source and an Mg source in an ordinary process, heating the cordierite honeycomb structure thus formed to a predetermined temperature again and then quenching it, or by quenching from a predetermined temperature during the transition from sintering to cooling. Cracks due to thermal shock are generated when the temperature difference (thermal shock temperature difference) is about 80° C. or larger between the time of heating and after quenching, while the crack size increases as the thermal shock temperature difference increases. The thermal shock temperature difference should be kept within about 900° C., since too large cracks make it difficult to maintain the shape of the honeycomb structure.

In the cordierite honeycomb structure, the amorphous phase is in the form of layers formed around the crystal phase. When thermal shock is applied by heating and then quenching the cordierite honeycomb structure, since there is a difference in the coefficient of thermal expansion between the amorphous phase and the crystal phase, a thermal stress corresponding to the difference in the coefficient of thermal expansion and to the thermal shock temperature difference is generated around the interface between the amorphous phase and the crystal phase. When the amorphous phase or the crystal phase is unable to endure the thermal stress, microscopic cracks are generated. The number of cracks generated can be controlled by the amount of amorphous phase. Shock waves of ultrasonic or vibration can also be used instead of thermal shock. When a weak portion of the cordierite honeycomb structure is unable to endure the shock wave, microscopic cracks are generated. The number of cracks generated can be controlled by the energy of the shock wave.

Among the pores which can carry the catalyst, missing defects of elements which constitute the ceramic are formed through elution of the constituent element of the cordierite or impurity by a liquid phase method. For example, the defects are formed when metal elements such as Mg and Al included in the cordierite crystal, alkali metal or alkali earth metal included in the amorphous phase or the amorphous phase itself dissolves into water of high temperature and high pressure, super-critical fluid or into a solution such as an alkali solution. Missing defects of these elements form pores which support the catalyst. The defects may also be formed chemically or physically by gas phase method. The chemical method includes dry etching and the physical method includes sputter etching, in which case the number of pores can be controlled by regulating the duration of etching or the amount of energy supplied.

A multitude of particles of elements capable of supporting the catalyst component may also be supported on the surface of the substrate ceramic by the substitution of elements. In this case, constituent elements of the ceramic, for example Si, Al and Mg in the case of cordierite are substituted by an element that has greater force for bonding with the catalyst than the substituted element and is capable of supporting the catalyst component by chemical bonding. Specifically, the substituting element may be from among those which are different from the constituent elements and have a d or f orbit in the electron orbits thereof, and preferably have an empty orbit in the d or f orbit or have two or more oxidation states. An element which has an empty orbit in the d or f orbit has an energy level near that of the catalyst being supported, which means a higher tendency to exchange electrons and bond with the catalyst component. An element which has two or more oxidation states also has a higher tendency to exchange electrons and provides the same effect.

Elements which have an empty orbit in the d or f orbit include W, Ti, V, Cr, Mn, Fe, Co, Ni, Zr, Mo, Ru, Rh, Ce, Ir, Pt, etc. of which one or more can be used. Among these, W, Ti, V, Cr, Mn, Fe, Co, Mo, Ru, Rh, Ce, Ir and Pt are elements which have two or more oxidation states. Besides these, elements which have two or more oxidation states include Cu, Ga, Ge, Se, Pd, Ag, Au, etc.

When substituting the constituent element of the ceramic with these substituting elements, a method may be employed in which the substituting element is added to the ceramic material and mixed. However, a method may also be employed in which the material including the constituent element to be substituted is reduced by an amount corresponding to the amount of substitution, followed by mixing, forming and drying, before being immersed in a solution which includes the substituting element for impregnation. The material is taken out of the solution, dried and then subjected to degreasing and sintering in an air atmosphere. This method of impregnating the preform is preferably employed, since the substituting element can be supported sufficiently on the surface of the preform and, as a result, the element is substituted on the surface during sintering, thus making it easier for a solid solution to form.

The amount of substituting element is set within a range from 0.01% to 50%, and preferably in a range from 5 to 20% of the substituted constituent element in terms of the number of atoms. In the case where the substituting element has a value of valence different from that of the constituent element of the substrate ceramic, lattice defects or oxygen defects are generated at the same time, depending on the difference in the valence, as described above. However, defects can be prevented from occurring by using a plurality of substituting elements and setting the sum of oxidation numbers of the substituting elements equal to the sum of oxidation numbers of the substituted constituent elements. Thus, the catalyst component may be supported only by bonding with the substituting elements while keeping the valence constant as a whole.

The second feature of the invention is that the ceramic carrier includes a metal element which has NOx absorbent capacity. The metal elements having NOx absorbent capacity include alkali metal elements such as Na, K, Rb, Cs and Fr, alkali earth metal elements such as Mg, Ca, Sr, Ba and Ra, rare earth elements such as Sc, Y, La and Ce, and transition metal elements such as Cr, Mn, Fe, Co, Ni, Cu and Zr. Any of these elements reacts with NOx included in the exhaust gas, thereby to form a nitrate, and has a function of absorbing or releasing NOx, in accordance with the property of the atmosphere.

According to the invention, a NOx absorbent capacity is given to the ceramic carrier of the invention which has the catalyst supporting capacity, by using at least one kind selected from these alkali metal elements, alkali earth metal elements, rare earth elements and transition metal elements in the form of a metal or oxide.

The metal element having NOx absorbent capacity can be included in the ceramic carrier either by (1) substituting a part of the constituent elements of the ceramic with the metal element having NOx absorbent capacity; or by (2) having a material which has NOx absorbent capacity supported by the pores or elements, which are provided on the ceramic carrier and are capable of supporting the catalyst. When the method (1) is employed, the ceramic carrier can be made to have catalyst supporting capacity and NOx absorbent capacity at the same time by forming the pores comprising defects in the ceramic crystal lattice, or using elements that can bond with the catalyst component and have NOx absorbent capacity, in addition to the process of this method. These methods will be described in detail later.

Values of valence of alkali metal elements and alkali earth metal elements which have NOx absorbent capacity are 1+ and 2+, respectively. As a result, when these elements are included in the ceramic by substituting the constituent element of the ceramic which has a different value of valence, an imbalance is caused in the oxygen content as the change in the valence is compensated for similarly to the methods \mathring{3} and \mathring{4} of forming defects which make the pores described previously, thus resulting in the formation of oxygen defects or lattice defects. In the case of cordierite, since the constituent elements have values of valence such as Si (4+), Al (3+) and Mg (2+), substituting these elements with an element of higher value of valence by using an alkali metal element or an alkali earth metal element as the defect forming element leads to the formation of pores due to oxygen defect and development of NOx absorbent capacity.

Substitution may be carried out similarly to the methods \mathring{3} and \mathring{4} by using the cordierite material having at least a part of the Si source and the Al source replaced by a compound of a defect forming element. In addition, because Ce, Cr, Mn, Fe, Co, Ni, Cu, etc. mentioned above as examples of substituting elements, which have an empty orbit in the d or f orbit, also have NOx absorbent capacity, similar effects can also be achieved by using these elements.

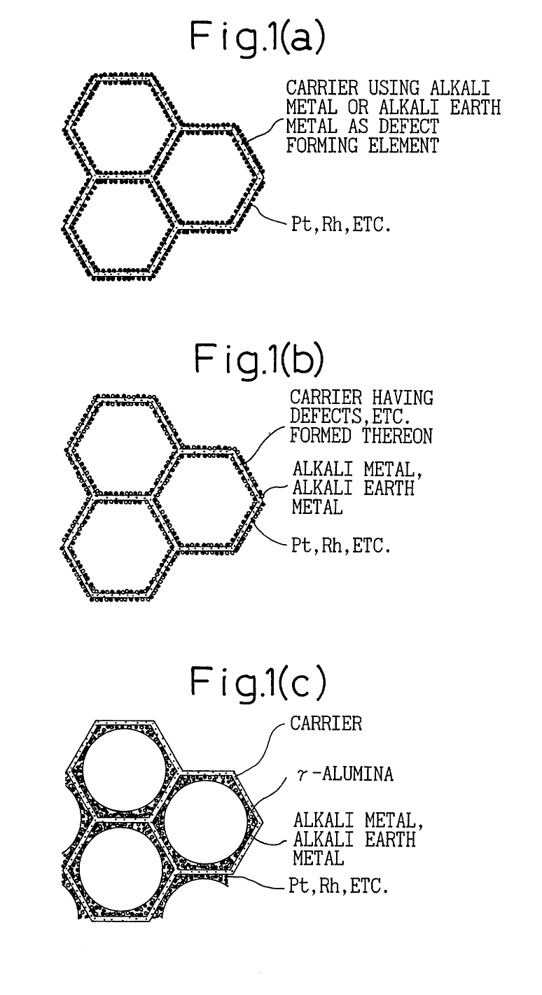

The ceramic catalyst which forms the NOx storage-reduction catalyst can be easily made by having the ceramic carrier support a catalyst component which consists of a noble metal, without forming a coating layer of γ-alumina. As shown in FIG. 1(a), the ceramic catalyst comprises a carrier of honeycomb structure which includes an alkali metal element, an alkali earth metal element or the like as the defect forming element that has NOx absorbent capacity, while the catalyst component such as Pt and Rh is supported in the pores formed thereby. Consequently, the main catalyst such as Pt or Rh and the metal element which has NOx absorbent capacity and serves as the assisting catalyst are brought near to each other. Thus, since NOx which is released from the catalyst can be easily reduced by the noble metal catalyst located nearby, the efficiency of detoxifying the NOx can be improved.

It is not necessary to form the pores in the ceramic carrier only by substitution with a metal element which has NOx absorbent capacity. The methods of forming the pores described above may be combined, such as by substituting with other elements, and forming microscopic cracks by applying thermal shock or shock waves after sintering. This makes it possible to increase the number of pores necessary to support the catalyst component.

The catalyst component is supported by immersing the cordierite honeycomb structure in a solution of the catalyst component dissolved in a solvent. This causes the catalyst component to be held in the pores such as lattice defects or cracks, or bonded with the substituting elements, thus making it possible to support 0.1 g/L or more catalyst component without forming a coating layer of γ-alumina. For the catalyst component, a noble metal catalyst such as Pt, Rh and Pd is preferably used. While the solvent for the catalyst component may be water, a solvent having smaller surface tension, for example, alcohol solvent such as ethanol, is preferable, since the defects or cracks which constitute the pores formed in the cordierite honeycomb structure are of microscopic size. While a solvent which has large surface tension such as water is difficult to infiltrate into the pores and is unable to make full use of the pores, the use of a solvent having smaller surface tension which can infiltrate into microscopic pores makes it possible to support 0.5 g/L or more catalyst component by making full use of the pores.

The ceramic carrier having NOx absorbent capacity can be made by depositing a metal element which has NOx absorbent capacity on a carrier constituted from a cordierite honeycomb structure which has pores or elements that are formed by the method described previously as in (2) and can support the catalyst, instead of substituting the constituent elements with the metal element which has NOx absorbent capacity. In this case, the metal element which has NOx absorbent capacity can be supported by a method similar to that of depositing the catalyst component. For example, the required quantity of assisting catalyst component can be supported easily without forming a coating layer of γ-alumina, by immersing the carrier in a solution of salt which includes the metal element having NOx absorbent capacity (nitrate, acetate, chloride, carbonate, etc.) dissolved in a solvent, thereby to impregnate the carrier with the solution. Further, by depositing the catalyst component such as a noble metal similarly, the ceramic catalyst body which supports the alkali metal element, alkali earth metal element, rare earth element or transition metal element which has NOx absorbent capacity and the noble metal catalyst such as Pt or Rh in the pores of the ceramic carrier as shown in FIG. 1(b) is obtained.

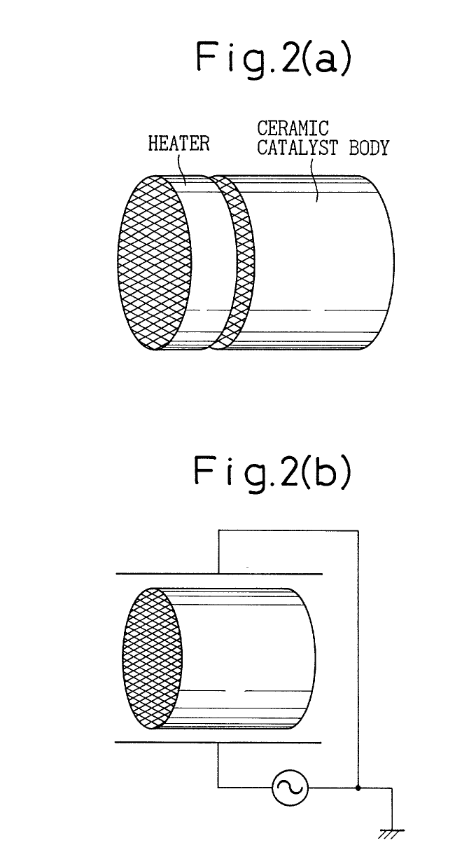

The ceramic catalyst body obtained as described above can decrease the heat capacity and the pressure loss in comparison to the ceramic catalyst of the prior art shown in FIG. 1(c). A constitution may also be employed in which thermal energy or electrical energy is supplied from the outside in order to improve the purification performance of the ceramic catalyst body. For example, purification performance can be improved from 90% to 97% by installing a heater in the upstream of the ceramic catalyst body as close as possible thereto (within 3 cm) as shown in FIG. 2(a), thereby to heat the exhaust gas entering the ceramic catalyst to 300° C. or higher. A similar effect can be achieved by installing a plasma generating device around the ceramic catalyst body as shown in FIG. 2(b) and supplying high frequency energy, thereby supplying plasma to the ceramic catalyst body.

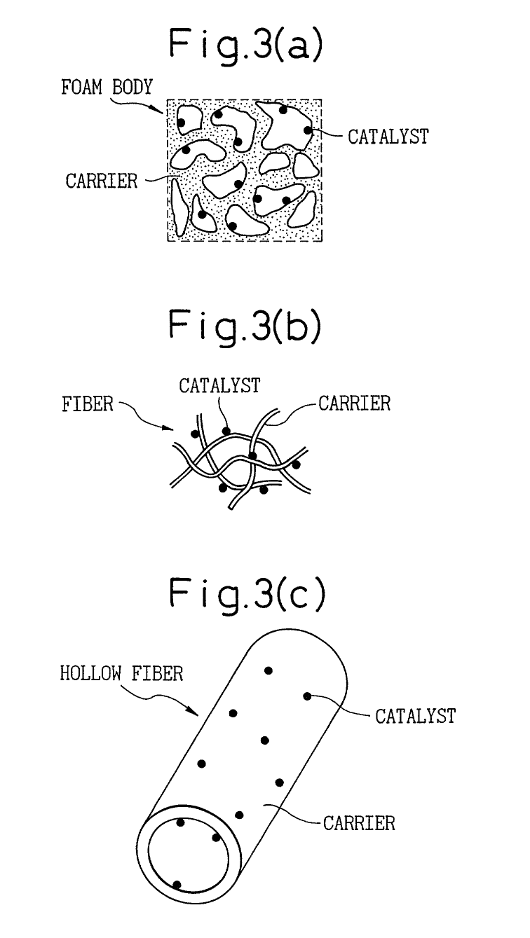

The carrier may be other than of honeycomb configuration, such as pellets or powder, and may also be a foam body, a fiber or hollow fiber as shown FIGS. 3(a) to 3(c), which have larger surface area than the honeycomb configuration. The foam body causes less pressure loss than pellets, powder, fiber and hollow fiber, and has a complicated gas flow passage which makes it easier for the gas and the catalyst to make contact with each other, thereby improving the reaction efficiency.

Examples and Comparative Examples of the invention will now be described.

### EXAMPLES 1 to 6

Cordierite materials comprising talc, kaolin, alumina and aluminum hydroxide and a compound of elements (Ba, Sr) having values of valence different from that of Si and having NOx absorbent capacity substituting 10% of the Si source were used as the starting materials. The starting materials were mixed in proportions around the theoretical composition of cordierite, to which proper quantities of a binder, a lubricant, a humectant and water were added and mixed into a paste. The paste was formed into a honeycomb structure having a cell wall thickness of 100 μm, a cell density of 400 cpsi (number of cells per 1 square inch) and a diameter of 50 mm. The honeycomb structure was sintered in an air atmosphere at 1390° C. for two hours, thus making the ceramic carriers of the invention (Examples 1, 2).

Ceramic carriers were also made by using cordierite materials comprising talc, kaolin, alumina and aluminum hydroxide and a compound of elements (Ba, Sr) having values of valence different from that of Al and having NOx absorbent capacity substituting 10% of the Al source and sintering similarly (Examples 3, 4). Further, ceramic carriers were also made by using cordierite materials comprising talc, kaolin, alumina and aluminum hydroxide and a compound of elements (Cs, K) having values of valence different from that of Mg and having NOx absorbent capacity substituting 10% of the Mg source and sintering similarly (Examples 5, 6).

The lattice constant for the aₒ axis of the cordierite crystal, the quantity of Pt supported, the coefficient of thermal expansion of the honeycomb structure in the direction of flow, the compressive strength in the direction of flow and the amount of NOx absorbed were measured on each of the honeycomb structures obtained, with the results shown in Table 1. The lattice constant for the aₒ axis of the cordierite crystal was determined from the position of the diffraction peak in the cordierite (100) plane by powder X ray diffraction, while adding Mn₂O₃ to the measured sample for the correction of diffraction peak position, thereby making reference to Mn₂O₃ (112) plane. The quantity of Pt supported was measured with a fluorescent X-ray analyzer by crushing the honeycomb structure which supported Pt that was supported by using platinum solution. The coefficient of thermal expansion was measured by the plunger type thermal expansion measuring method in terms of mean value of coefficients of thermal expansion over a range from 25 to 800° C. The compressive strength of the honeycomb structure in the direction of flow was measured by applying a load to a cylindrical sample measuring 1 inch in diameter and 1 inch in length, which was cut from the honeycomb, and determining the pressure at which the cylindrical sample ruptured. The amount of NOx absorbed was determined by flowing 5% of O₂ gas in a 1000 ppm NO gas atmosphere (N₂ balanced) and measuring the loss in the amount of NOx, namely the amount of NOx absorbed in the ceramic catalyst body, from the difference in the NOx concentration between the inlet and the outlet of the ceramic catalyst body.

TABLE 1
Substitution method

| | | | | | | Amount of |
|---|---|---|---|---|---|---|
| | | Lattice | Quantity of | Coefficient of | Compressive | NOx |
| | Substituting | constant for | Pt supported | thermal expansion | strength | absorbed |
| | element | a₀ axis (nm) | (g/L) | (× 10⁻⁶/° C.) | (Mpa) | (mol) |
| Example 1 | Ba | 0.840 | 8.6 ± 0.4 | 0.94 ± 0.05 | 11.5 ± 1.0 | 0.9 ± 0.06 |
| Example 2 | Sr | 0.847 | 8.1 ± 0.5 | 0.97 ± 0.03 | 11.7 ± 1.1 | 0.8 ± 0.07 |
| Example 3 | Ba | 0.845 | 7.5 ± 0.3 | 0.88 ± 0.03 | 12.2 ± 1.2 | 0.8 ± 0.06 |
| Example 4 | Sr | 0.840 | 7.3 ± 0.4 | 0.90 ± 0.04 | 12.4 ± 1.1 | 0.7 ± 0.07 |
| Example 5 | Cs | 0.841 | 7.5 ± 0.4 | 0.97 ± 0.06 | 11.2 ± 1.0 | 1.0 ± 0.08 |
| Example 6 | K | 0.840 | 7.1 ± 0.3 | 0.98 ± 0.06 | 11.4 ± 0.9 | 0.9 ± 0.09 |

### EXAMPLES 7 to 10

Cordierite materials comprising talc, kaolin, alumina and aluminum hydroxide and tungsten oxide (WO₃) having a value of valence different from that of Al substituting 10% of the Al source were mixed in proportions around the theoretical composition of cordierite. Proper quantities of a binder, a lubricant, a humectant and water were added to the mixture of the starting materials and mixed into a paste. The paste was formed into a honeycomb structure having a cell wall thickness of 100 μm, a cell density of 400 cpsi (number of cells per 1 square inch) and a diameter of 50 mm. The honeycomb structure was sintered in an air atmosphere at 1390° C. for two hours. Ions of elements (Ba, Sr, Cs, K) having NOx absorbent capacity were supported on the honeycomb structure obtained as described above. Water or ethanol was used as the solvent for depositing the elements having NOx absorbent capacity. The honeycomb structure immersed in the solution and then dried was sintered in an air atmosphere, thus making the ceramic carriers of the invention.

The quantity of Pt supported, the coefficient of thermal expansion of the honeycomb structure in the direction of flow, the compressive strength in the direction of flow and the amount of NOx absorbed were measured on each of the honeycomb structures obtained, with the results shown in Table 2.

TABLE 2
Deposition method

| | | | | | | Amount of |
|---|---|---|---|---|---|---|
| | | | | Coefficient of | Compressive | NOx |
| | Substituting | Supported | Quantity of Pt | thermal expansion | strength | absorbed |
| | element | element | supported (g/L) | (× 10⁻⁶/° C.) | (Mpa) | (mol) |
| Example 7 | W | Ba | 5.2 ± 0.6 | 0.88 ± 0.03 | 13.4 ± 1.4 | 1.5 ± 0.11 |
| Example 8 | W | Sr | 4.8 ± 0.5 | 0.90 ± 0.04 | 13.0 ± 1.3 | 1.3 ± 0.10 |
| Example 9 | W | Cs | 4.9 ± 0.5 | 0.91 ± 0.04 | 14.4 ± 1.4 | 1.8 ± 0.12 |
| Example 10 | W | K | 4.5 ± 0.4 | 0.93 ± 0.04 | 13.2 ± 1.2 | 1.7 ± 0.11 |
| Comparative | — | Ba | — | 1.00 ± 0.05 | 11.0 ± 1.7 | 0.9 ± 0.21 |
| Example 1 | | | | | | |

A carrier of cordierite honeycomb structure was made for the purpose of comparison by using cordierite materials comprising talc, kaolin, alumina and aluminum hydroxide similarly to the above, without using a substituting element, and was coated with γ-alumina. Ions of element (Ba) having NOx absorbent capacity and a Pt catalyst were supported on the surface of the honeycomb structure obtained as described above. The quantity of Pt supported, the coefficient of thermal expansion of the honeycomb structure in the direction of flow, the compressive strength in the direction of flow and the amount of NOx absorbed were measured on the honeycomb structure obtained, similarly to the Examples described previously, with the results shown in Table 2. The quantity of Pt supported by the carrier was measured on the ceramic carrier not coated with γ-alumina.

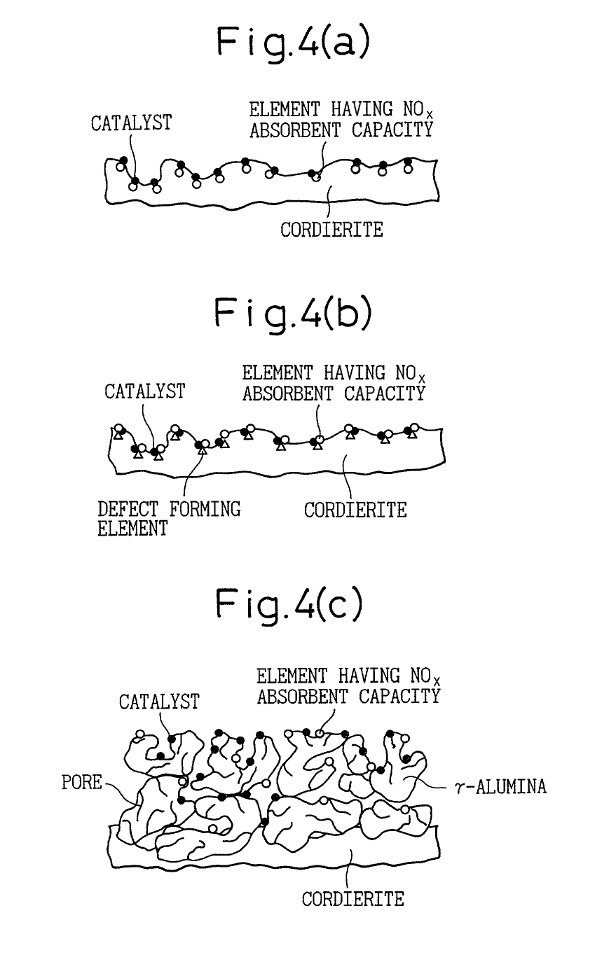

As will be clear from Tables 1 and 2, in Examples 1 to 6, in which cordierite constituent elements of Si, Al and Mg were substituted with elements of lower valence, it was confirmed that the lattice constant for the aₒ axis of the cordierite crystal was smaller and the number of oxygen atoms included in the cordierite unit crystal lattice decreased, thus forming oxygen defects. When Pt was supported on the ceramic carrier, 4.5 to 8.6 g/L of Pt was supported and it is assumed that Pt is supported in the oxygen defects formed by the element which has NOx absorbent capacity as shown in FIG. 4(a). The requirement for the catalyst carrier to have a coefficient of thermal expansion of within 1.0×10⁻⁶/°C. was satisfied in all of Examples 1 to 6. The compressive strength in the direction of flow was 11.92 MPa or higher in all of these Examples, exceeding the value of 10 MPa required to endure the load incurred when assembled in a catalyst converter. The quantity of NOx absorbed was 0.7 mol or larger, indicating a practical capability for use as the NOx absorber.

In Examples 7 to 10, an element having NOx absorbent capacity and a Pt catalyst were supported on the ceramic carrier having oxygen defects formed therein by element substitution as shown in FIG. 4(b). Examples 7 to 10 also showed that the quantity of Pt supported, coefficient of thermal expansion of the honeycomb structure in the direction of flow, compressive strength in the direction of flow and the amount of NOx absorbed, were at similar levels to those of Examples 1 to 6.

Since the ceramic carrier of the invention has the catalyst supported in the vicinity of the defect forming elements which have NOx absorbent capacity included in the cordierite unit crystal lattice as shown in FIG. 4(a), maximum NOx absorbent capacity can be obtained. As a result, variations in the NOx absorbent capacity decrease and products of stable quality can be supplied. In the case of constitution shown in FIG. 4(b), too, since the element having NOx absorbent capacity and Pt catalyst are supported relatively close to each other, the NOx absorbent capacity increases as similar effects can be obtained, although the variations are little larger. With the constitution of Comparative Example (FIG. 4(c)), by contrast, since the element having NOx absorbent capacity and the Pt catalyst are supported on the γ-alumina coating layer which has a large surface area, the catalyst elements are supported at different distances, resulting in larger variations in the NOx absorbent capacity.

### EXAMPLES 11 to 14

Ceramic carriers were made by using cordierite materials comprising talc, kaolin, alumina and aluminum hydroxide and substituting Al which is a constituent element of cordierite with W. Starting materials were prepared by subtracting 5 to 20% of the Al source from the cordierite material, and were formed into a honeycomb similarly to the Examples described above, and dried. The dried preform was immersed in a solution of WO₃, a compound of W used as the substituting element. The preform having much WO₃ on the surface of the honeycomb preform was taken out of the solution and dried. After degreasing at 900° C. in an air atmosphere, the honeycomb structure was sintered in an air atmosphere at a heating rate of 5 to 75° C./hr and held at a temperature of 1300 to 1390° C.

The honeycomb structure thus obtained was immersed in an aqueous or alcohol solution including the nitrate of a metal element which has NOx absorbent capacity (Na, Mg, Y, Zr) and a catalyst material (0.07 mol/L of chloroplatinate and 0.05 mol/L of rhodium chloride). The honeycomb structure taken out of the solution was dried and sintered at 500° C. for two hours in an air atmosphere, thereby to obtain the ceramic catalyst body.

The amount of NOx absorbed in the ceramic catalyst body thus obtained was measured by a method similar to that described above, with the result shown in Table 3. It was confirmed that, in addition to the alkali metal element (Na) having strong basicity and the alkali earth metal element (Mg), the rare earth element (Y) and the transition metal elements (Zr) also have NOx absorbent capacity. Through XPS measurement of the bonding energy of W which was used as the substituting element, a change in the bonding energy was observed when the catalyst component and the element having NOx absorbent capacity were supported on the ceramic carrier, indicating occurrence of chemical bonding between these elements. No change was observed in the value of valence of other constituent elements of the ceramic carrier.

TABLE 3

| | Example 11 | Example 12 | Example 13 | Example 14 |
|---|---|---|---|---|
| NOx absorbent | Na | Mg | Y | Zr |
| metal | | | | |
| Amount of | 2.1 × 10⁻⁴ | 1.9 × 10⁻⁴ | 1.1 × 10⁻⁴ | 1.0 × 10⁻⁴ |
| NOx absorbed | | | | |
| (mol NO) | | | | |

### EXAMPLES 15, 16

Cordierite materials comprising talc, kaolin, alumina and aluminum hydroxide and 10% of tungsten oxide (WO₃) having valence of different value from Si substituting 20% of the Si source and 10% of a compound of elements (Ba, Sr) having valence of different value from Si and having NOx absorbent capacity were mixed in proportions around the theoretical composition of cordierite. Proper quantities of a binder, a lubricant, a humectant and water were added to the mixture and mixed into a paste. The paste was formed into a honeycomb structure having a cell wall thickness of 100 μm, a cell density of 400 cpsi (number of cells per 1 square inch) and a diameter of 50 mm. The honeycomb structure was sintered in an air atmosphere at 1290° C. for two hours, thereby making the ceramic carriers of the invention (Examples 15, 16).

The quantity of Pt supported by the carrier, the coefficient of thermal expansion of the honeycomb structure in the direction of flow, the compressive strength in the direction of flow and the amount of NOx absorbed were measured on each of the honeycomb structures obtained, with the results shown in Table 4.

### EXAMPLES 17, 18

Cordierite materials comprising talc, kaolin, alumina and aluminum hydroxide, 10% of tungsten oxide (WO₃) having a valence of different value from Si substituting 20% of the Si source and 10% of cobalt oxide (CoO) were mixed in proportions around the theoretical composition of cordierite. Proper quantities of a binder, a lubricant, a humectant and water were added to the mixture and mixed into a paste. The paste was formed into a honeycomb structure having a cell wall thickness of 100 μm, a cell density of 400 cpsi (number of cells per 1 square inch) and a diameter of 50 mm. The honeycomb structure was sintered in an air atmosphere at 1290° C. for two hours, thereby making the ceramic carrier of the invention.

Ions of elements (Ba, K) having NOx absorbent capacity were supported on the honeycomb structure obtained as described above. Water or ethanol was used as the solvent for depositing the elements having NOx absorbent capacity. The honeycomb structure immersed in the solution and then dried was sintered in an air atmosphere, thus making the ceramic carriers of the invention (Examples 17, 18).

The quantity of Pt supported by the carrier, the coefficient of thermal expansion of the honeycomb structure in the direction of flow, the compressive strength in the direction of flow and the amount of NOx absorbed were measured on each of the honeycomb structures obtained, with the results shown in Table 4.

TABLE 4

| | | | | Coefficient of | | |
|---|---|---|---|---|---|---|
| | | Lattice | Quantity of | thermal | Compressive | Amount of |
| | Substituting | constant for | Pt supported | expansion | strength | NOx absorbed |
| | element | a₀ axis (nm) | (g/L) | (× 10⁻⁶/° C.) | (Mpa) | (mol) |
| Example 15 | W/Ba | 0.842 | 7.2 ± 0.6 | 0.98 ± 0.03 | 11.4 ± 1.0 | 1.1 ± 0.06 |
| Example 16 | W/Sr | 0.843 | 6.8 ± 0.5 | 0.97 ± 0.04 | 12.0 ± 1.0 | 1.2 ± 0.06 |
| | | | | Coefficient of | | |
| | | | Quantity of | thermal | Compressive | Amount of |
| | Substituting | Supported | Pt supported | expansion | strength | NOx absorbed |
| | element | element | (g/L) | (× 10⁻⁶/° C.) | (Mpa) | (mol) |
| Example 17 | W/Co | Ba | 5.9 ± 0.5 | 0.95 ± 0.04 | 11.4 ± 1.2 | 1.8 ± 0.12 |
| Example 18 | W/Co | K | 5.5 ± 0.4 | 0.98 ± 0.04 | 11.2 ± 1.0 | 1.7 ± 0.11 |

What is claimed is:

1. A ceramic carrier comprising a substrate ceramic and a multitude of pores or elements capable of supporting a catalyst component directly on the surface of the substrate ceramic, which contains metal elements having NOx absorbent capacity.

2. The ceramic carrier according to claim 1, wherein the pores capable of directly supporting the catalyst component comprise at least one kind selected from among a group consisting of defects in the ceramic crystal lattice, microscopic cracks in the ceramic surface and missing defects of the elements which constitute the ceramic, and the elements capable of directly supporting the catalyst component are elements which substitute for a part of the constituent elements of the substrate ceramic.

3. The ceramic carrier according to claim 1, wherein the defects in the ceramic crystal lattice which constitute the pores capable of directly supporting the catalyst component are formed and NOx absorbent capacity is given by substituting a part of the constituent elements of the ceramic with the metal elements having NOx absorbent capacity.

4. The ceramic carrier according to claim 1, wherein NOx absorbent capacity is given by supporting the metal elements which have NOx absorbent capacity in the pores capable of directly supporting the catalyst component.

5. The ceramic carrier according to claim 1, wherein the metal element having NOx absorbent capacity is an alkali metal element, an alkali earth metal element, a rare earth element or a transition metal element.

6. The ceramic carrier according to claim 1, wherein the substrate ceramic includes cordierite as the major component.

7. The ceramic carrier according to claim 1 wherein the carrier has a form of at least one kind selected from among a group consisting of a honeycomb, pellets, powder, a foam body, a fiber and a hollow fiber.

8. The ceramic carrier according to claim 1, wherein the pores which can directly support the catalyst component have a diameter or width 1000 times the diameter of the catalyst ion to be supported or smaller, and the density of pores is 1×10¹¹/L or higher.

9. A ceramic catalyst body comprising the ceramic carrier of claim 1 and a catalyst component supported directly on the surface the ceramic carrier without forming a coating layer.

10. The ceramic catalyst body according to claim 9, wherein the catalyst is supported in the vicinity of the metal elements having NOx absorbent capacity.

11. The ceramic catalyst body according to claim 9 wherein the catalyst component is a noble metal.
